(19) United States
(12) Patent Application Publication
(10) Pub. No.: US 2010/0126980 A1
(43) Pub. Date: May 27, 2010

(54) DIRECT VESSEL HEATING FOR DISSOLUTION TESTING

(76) Inventor: Jeremy Fetvedt, Raleigh, NC (US)

Correspondence Address: Varian Inc.;Legal Department, 3120 Hansen Way D-102, Palo Alto, CA, 94304, US

(21) Appl. No.: 12/277,215

(22) Filed: Nov. 24, 2008

(51) Int. Cl. F27D 11/02; B23P 11/00

(52) U.S. Cl. 219/441; 29/428

(57) ABSTRACT

A dissolution test vessel configured for direct vessel heating includes a lateral wall, a resistive heating element, and a temperature-sensing element. The resistive heating element and the temperature-sensing element are bonded directly to the lateral wall, and may be formed by dispensing flowable materials onto the lateral wall. The resistive heating element includes a contiguous first heating element end, heating element section, and second heating element end. The temperature-sensing element includes a contiguous first sensing element end, sensing element section, and second sensing element end. The vessel may communicate with a heater control system, which may be provided with a dissolution test apparatus at which the vessel is mounted.

### FIELD OF THE INVENTION

The present invention relates generally to dissolution testing of analyte-containing media. More particularly, the invention relates to heating and monitoring the temperature of media contained in test vessels of a dissolution test apparatus by utilizing a direct vessel heating technique, and to test vessels that integrally include direct vessel heating components.

### BACKGROUND OF THE INVENTION

Dissolution testing is often performed as part of preparing and evaluating soluble materials, particularly pharmaceutical dosage forms (e.g., tablets, capsules, and the like) consisting of a therapeutically effective amount of active drug carried by an excipient material. Typically, dosage forms are dropped into test vessels that contain dissolution media of a predetermined volume and chemical composition. For instance, the composition may have a pH factor that emulates a gastro-intestinal environment. Dissolution testing can be useful, for example, in studying the drug release characteristics of the dosage form or in evaluating the quality control of the process used in forming the dose. To ensure validation of the data generated from dissolution-related procedures, dissolution testing is often carried out according to guidelines approved or specified by certain entities such as United States Pharmacopoeia (USP), in which case the testing must be conducted within various parametric ranges. The parameters may include dissolution media temperature, the amount of allowable evaporation-related loss, and the use, position and speed of agitation devices, dosage-retention devices, and other instruments operating in the test vessel.

As a dosage form is dissolving in the test vessel of a dissolution system, optics-based measurements of samples of the solution may be taken at predetermined time intervals through the operation of analytical equipment such as a spectrophotometer. The analytical equipment may determine analyte (e.g. active drug) concentration and/or other properties. The dissolution profile for the dosage form under evaluation—i.e., the percentage of analytes dissolved in the test media at a certain point in time or over a certain period of time—can be calculated from the measurement of analyte concentration in the sample taken. In one specific method employing a spectrophotometer, sometimes referred to as the sipper method, dissolution media samples are pumped from the test vessel(s) to a sample cell contained within the spectrophotometer, scanned while residing in the sample cell, and in some procedures then returned to the test vessel(s). In another more recently developed method, sometimes referred to as the in situ method, a fiber-optic “dip probe” is inserted directly in a test vessel. The dip probe includes one or more optical fibers that communicate with the spectrophotometer. In the in situ technique, the spectrophotometer thus does not require a sample cell as the dip probe serves a similar function. Measurements are taken directly in the test vessel and thus optical signals rather than liquid samples are transported between the test vessel and the spectrophotometer via optical fibers.

During the course of dissolution testing, it is desirable and often required to heat the media residing in the vessels of the dissolution test apparatus, and control the temperature of this media at a constant level or according to a predetermined temperature profile. For instance, when operating in accordance with certain USP guidelines, the media must be maintained at 37±0.5° C. One way to control the temperature of the media is to provide a water bath with the dissolution test apparatus. The dissolution test vessels are supported by the dissolution test apparatus such that the vessels are at least partially immersed in the water bath. Heated water is circulated through the water bath and thus into thermal contact with each vessel, whereby heat is transferred from the water bath to the media contained in the vessels. Another way to control media temperature is by way of Direct Vessel Heating (DVH™) technology developed by Varian, Inc., Palo Alto, Calif. In this latter case, a heating element is attached to each vessel. The heating element is a multi-layered structure that includes resistive heating elements and temperature-sensing elements sandwiched between polymeric layers. Accordingly, the heating of each vessel of the dissolution system is independently controllable and the need for a water bath and associated components (water heater, pump, plumbing, etc.) is eliminated. Examples of vessels provided with this type of heating element are described in U.S. Pat. Nos. 6,303,909 and 6,727,480, assigned to the assignee of the present disclosure and incorporated herein by reference in their entireties.

While vessels provided with heating elements of the type noted above generally perform well, there is a need for further improvements in the direct heating of vessels. The known heating elements require several layers of material, and must first be fabricated as a complete article and then applied to the vessels. Typically, the as-constructed heating elements are manually applied with the use of adhesives, which may result in variations in performance from one vessel to another. Moreover, the various materials required and fabrication process are costly. Therefore, there is a need for providing directly heated vessels that are fabricated more consistently, function more precisely, and are less costly.

### SUMMARY OF THE INVENTION

To address the foregoing problems, in whole or in part, and/or other problems that may have been observed by persons skilled in the art, the present disclosure provides methods, processes, systems, apparatus, instruments, and/or devices, as described by way of example in implementations set forth below.

According to one implementation, a dissolution test vessel configured for direct vessel heating is provided. The dissolution test vessel includes a lateral wall, a resistive heating element, and a temperature-sensing element. The lateral wall is disposed about a longitudinal axis of the vessel and includes an upper end, a lower end axially spaced from the upper end, and an outside surface extending from the upper end to the lower end. The resistive heating element is bonded directly to the outside surface and includes a first heating element end, a second heating element end, and a heating element section contiguously running from the first heating element end, over a heating zone of the lateral wall and to the second heating element end. The heating element section runs along at least two different directions. The temperature-sensing element is bonded directly to the outside surface and includes a first sensing element end, a second sensing element end, and a sensing element section contiguously running from the first sensing element end, over a temperature sensing zone of the lateral wall and to the second sensing element end. The sensing element section runs along at least two different directions.

According to another implementation, a dissolution test apparatus configured for direct vessel heating is provided. The dissolution test apparatus includes a vessel support member having an aperture, a heater control system, and a vessel mounted at the vessel support member. The vessel includes a resistive heating element bonded directly an outside surface of the vessel, and a temperature-sensing element bonded directly to the outside surface. The resistive heating element and the temperature-sensing element communicate with the heater control system.

According to another implementation, a method is provided for fabricating a dissolution test vessel. The method includes depositing a first flowable material directly on an outside surface of a lateral wall of a vessel to form a resistive heating element. A second flowable material is deposited directly on the outside surface to form a temperature-sensing element. A contact block is attached to the vessel and placed in communication with the resistive heating element and the temperature-sensing element. A clear film may be applied directly to the outside surface wherein the film covers at least a portion of the resistive heating element and the temperature-sensing element.

Other devices, apparatus, systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE DRAWINGS

The invention can be better understood by referring to the following figures. The components in the figures are not necessarily to scale, emphasis instead being placed upon illustrating the principles of the invention. In the figures, like reference numerals designate corresponding parts throughout the different views.

FIG. 1 is a perspective view of an example of a vessel provided in accordance with the teachings of the present disclosure.

FIG. 2 is an elevation view of the vessel illustrated in FIG. 1.

FIG. 3 is another elevation view of the vessel illustrated in FIG. 1.

FIG. 4 is a detailed view of the region designated “A” in FIG. 2.

FIG. 5 is a cross-sectional elevation view of a portion of the vessel illustrated in FIGS. 1 to 3.

FIG. 6 is an elevation view of the vessel illustrated in FIGS. 1 to 3 mounted to a vessel support member and communicating with a vessel heating control system.

FIG. 7 is a schematic view of an example of a vessel heating control system according to the teachings of the present disclosure.

FIG. 8 is a schematic view of a vessel being fabricated according to an example taught in the present disclosure.

FIG. 9 is a perspective view of an example of a dissolution test apparatus at which one or more vessels taught in the present disclosure may be operated.

### DETAILED DESCRIPTION OF THE INVENTION

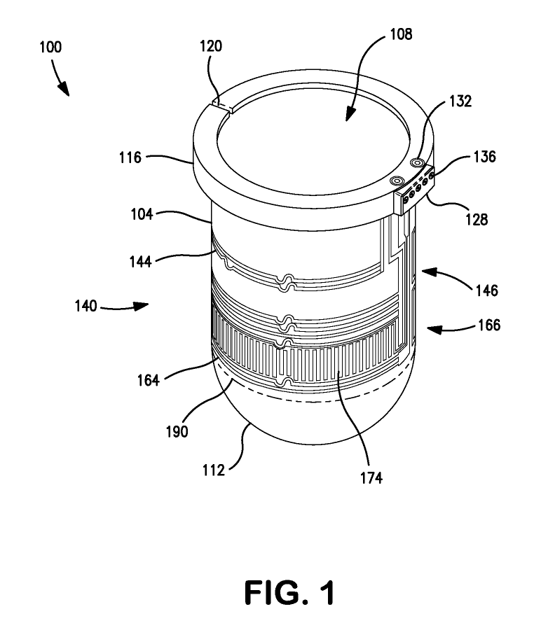

An example of a vessel with integral direct vessel heating capability will now be described with reference to FIGS. 1-6.

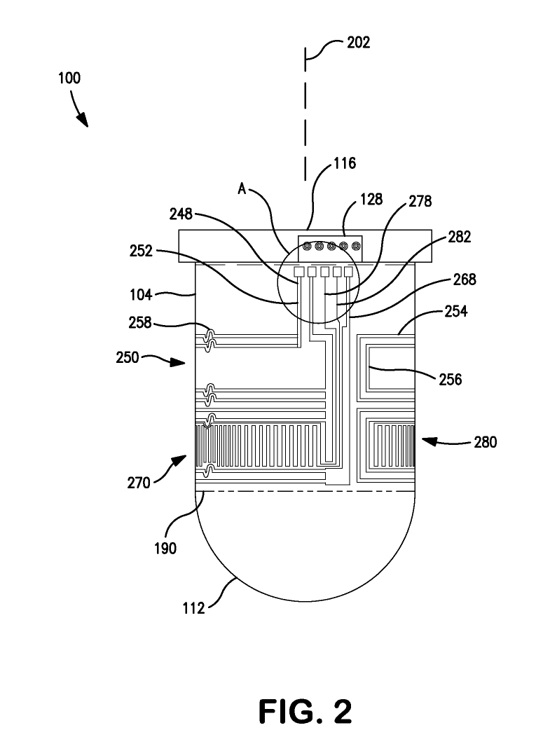

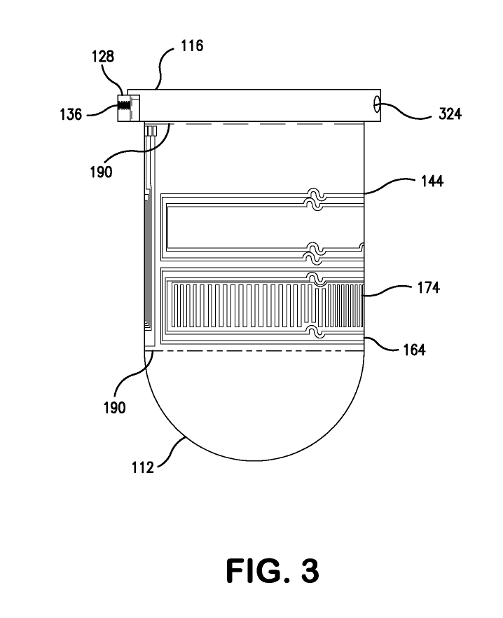

FIG. 1 is a perspective view and FIGS. 2 and 3 are elevation views of an example of a vessel 100 according to the present teachings. Typically, the vessel 100 has a cylindrical shape relative to a central or longitudinal axis 202 (FIG. 2) of the vessel, but more generally the vessel 100 may have any shape suitable for containing dissolution media and receiving a stirring device and/or other types of in situ operative components. The vessel 100 generally includes a lateral wall or section 104 generally parallel with the central axis 202. The lateral wall 104 terminates at an upper end 108, which is open to the interior of the vessel 100 unless a vessel cover (not shown) is provided. Opposite to the upper end 108, the lateral wall 104 includes a lower end at which a bottom section 112 of the vessel 100 adjoins the lateral wall 104. The bottom section 112 may be hemispherical or rounded as illustrated or may have any other suitable shape. Typically, the bottom end 112 is completely closed but in other implementations may include an opening and an accompanying closure device, valve, or the like.

The vessel 100 may include a flanged section 116 (e.g., rim, flange, etc.), the outermost diameter of which is greater than the outermost diameter of the lateral wall 104. The flanged section 116 facilitates the mounting of the vessel 100 at a vessel support member such as may be provided with a dissolution test apparatus. Typically, the vessel support member is provided in the form of a plate that has a plurality of apertures serving as vessel mounting sites supporting a plurality of respective vessels. The flanged section 116 may also be configured to facilitate centering of the vessel 100 within the aperture of the vessel support member. For this purpose, the flanged section 116 may be a separate component in the form of a collar or ring that is attached to the lateral wall 104 at the upper end 108. As an example, the flanged section 116 may include a gap 120 (FIG. 1) and one or more bores 324 (FIG. 3) leading to the gap 120. A screw or other fastener, tangentially oriented relative to the curvature of the vessel 100, may be inserted through the bore(s) 324 and across the gap 120 to secure the flanged section 116 to the lateral wall 104. The flanged section 116 may be similar to the TruCenter™ vessel commercially available from Varian, Inc., Palo Alto, Calif., or to embodiments disclosed in U.S. Pat. Nos. 6,562,301 and 6,673,319, assigned to the assignee of the present disclosure. As an alternative to the illustrated two-piece design of the vessel 100, the flanged section 116 may be a rim integrally formed with the lateral wall 104.

The vessel 100 may further include a contact block (or contact element) 128. The contact block 128 may be attached to or form a part of the flanged section 116, as described further below. In the illustrated example, the contact block 128 is removably attached to the flanged section 116 by way of screws 132. The contact block 128 may include a first set of contacts (not shown) located at the underside of the contact block 128, and a second set of contacts 136 located at an outer surface of the contact block 128. As illustrated in FIGS. 1 and 3, the contact block 128 may protrude radially outward from the flanged section 116 relative to the central axis 202 (FIG. 2). The function of the contact block 128 is described below.

The vessel 100 includes a direct vessel heating area 140. The direct vessel heating area 140 may be fabricated over a large portion of the outside surface of the lateral wall 104. For instance, the direct vessel heating area 140 may span over a large portion of the axial length of the lateral wall 104 (i.e., in the direction of the central axis 202), and fully circumscribe the lateral wall 104 to ensure uniform heating and temperature control of the media contents of the vessel 100.

Referring to FIG. 1, the direct vessel heating area 140 may include a continuous, first resistive heating element 144 configured to provide heat over a first heating zone 146 of the direct vessel heating area 140. By “resistive” is meant that the material of the first heating element 144 is electrically resistive and thus dissipates heat in response to electrical current.

Referring to FIG. 2, to provide heat throughout the first heating zone 146, the first resistive heating element 144 includes a first heating element end 248, a first main heating element section 250, and a second heating element end 252. The material constituting the first resistive heating element 144 is contiguous from the first heating element end 248, to the first main heating element section 250, and to the second heating element end 252. Hence, establishing an electrical current from the first heating element end 248, through the first main heating element section 250, and to the second heating element end 252 generates heat. A majority of the heat is generated from first main heating element section 250 and thus in the first heating zone 146 defined thereby. For this purpose, the first main heating element section 250 may be configured or arranged in any suitable pattern. Generally, the first main heating element section 250 includes portions that run in at least two directions to provide sufficient heating coverage over the first heating zone 146. In the illustrated example, the first main heating element section 250 includes horizontal portions 254 and vertical portions 256. Moreover, again as an example, more than one horizontal portion 254 and/or vertical portion 256 may branch off of the first heating element end 248 and/or the second heating element end 252. Alternative patterns may include, as examples, a sawtooth pattern, a square wave pattern, a trapezoidal pattern, a sinusoidal pattern, other serpentine patterns, and combinations of the foregoing. The first main heating element section 250 may also include fuse links 258, which by example are illustrated as short sinusoidal portions.

Referring to FIG. 1, in the present example, the direct vessel heating area 140 also includes a continuous, second resistive heating element 164 configured to provide heat over a second heating zone 166 of the direct vessel heating area 140.

Referring to FIG. 2, to provide heat over the second heating zone 166, the second resistive heating element 164 includes a third heating element end 268, a second main heating element section 270, and a fourth heating element end. In the illustrated example, the fourth heating element end and the second heating element end 252 (associated with the first resistive heating element 144) are one and the same, i.e., a single termination common to both the first resistive heating element 144 and the second resistive heating element 164 is provided. The configuration, patterning or arrangement, and operation of the second resistive heating element 164 may be the same or similar as described above regarding the first resistive heating element 144.

The dual-zone heating design of the illustrated vessel 100 is useful for accommodating the operation of the vessel 100 when utilizing different levels of media during different tests. The dual-zone heating design is illustrated as an example. In other implementations, the direct vessel heating area 140 may include a single resistive heating element and corresponding single heating zone, or may include more than two resistive heating elements and correspondingly distinct heating zones.

The direct vessel heating area 140 may further include a continuous temperature-sensing element 174 configured to measure media temperature. In the illustrated example, the temperature-sensing element 174 runs over a temperature sensing zone that may be located within the second heating zone 166. The second heating zone 166 is the lower of the two heating zones 146 and 166 and media is most likely to be filled at least to an elevation level coextensive with the second heating zone 166. Alternatively, the temperature-sensing element 174 may be located within the upper or first heating zone 146, or in both heating zones 146 and 166, or two temperature-sensing elements may be located in the respective heating zones 146 and 166. Also in the illustrated example, the temperature-sensing element 174 is located “within” the second heating zone 166 so as to facilitate fabrication of both the second resistive heating element 164 and the temperature-sensing element 174. Alternatively, the temperature-sensing element 174 may overlap into both heating zones 146 and 166. To provide an accurate measurement of media temperature, the temperature-sensing element 174 may cover a large portion of the direct vessel heating area 140. In the illustrated example, the temperature-sensing element 174 covers a large portion of the second heating zone 166.

Referring to FIG. 2, the temperature-sensing element 174 includes a first sensing element end 278, a main sensing element section 280, and a second sensing element end 282. The material constituting the temperature-sensing element 174 is contiguous from the first sensing element end 278, to the main sensing element section 280, and to the second sensing element end 282. In this example, the resistivity of the material constituting the temperature-sensing element 174 varies with temperature and thus the temperature of the media, which is in thermal contact with the temperature-sensing element 174 across the lateral wall 104 of the vessel 100, may be measured by sensing a change in the electrical current through the temperature-sensing element 174 or in the voltage across the temperature-sensing element 174. The main sensing element section 280 may be configured or arranged in any suitable pattern. Generally, as in the case of the resistive heating elements 144 and 164, the main sensing element section 280 includes portions that run in at least two directions to provide sufficient temperature-measurement coverage over the second heating zone 166. In the illustrated example, the main sensing element section 280 includes horizontal portions and vertical portions arranged in a sinusoidal or serpentine pattern. Alternative patterns may be utilized, as noted above in the case of the resistive heating elements.

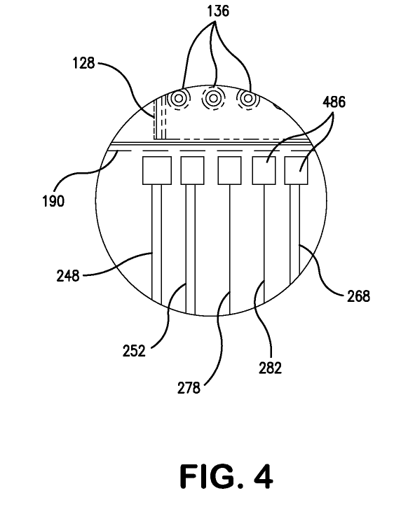

FIG. 4 is a detailed view of the region designated “A” in FIG. 3. As best shown in FIG. 4, the heating element ends 248, 252, 268 and the sensing element ends 278 and 282 may be located proximate to each other and to the contact block 128. By this configuration, relatively short jumper wires or other types of electrical interconnections (e.g., a flexible ribbon cable) may be provided to electrically interconnect the heating element ends 248, 252, 268 and the sensing element ends 278 and 282 respectively to the first set of contacts (not shown) located at the underside of the contact block 128, and thus to the second set of contacts 136 located at an outer surface of the contact block 128. To facilitate making the electrical contact with jumper wires or the like, each of the heating element ends and the sensing element ends may terminate at a respective bond pad 486.

All portions of the resistive heating element(s) 144 and 164 and the temperature-sensing element(s) 174, including their respective ends 248, 252, 268, 278, 282, main sections 250, 270, 280, and bond pads 486, are directly bonded to the outer surface of the lateral wall 104 of the vessel 100. That is, no intervening layers of material exist between the resistive heating element(s) 144 and 164 and the temperature-sensing element(s) 174 and the lateral wall 104. Accordingly, these components comprising the direct vessel heating area 140 of the vessel 100 are formed integrally with the vessel 100, as opposed to comprising a separate, multi-layered article that must be applied to the vessel 100 through the use of adhesives or other means. The resistive heating element(s) 144 and 164 and the temperature-sensing element(s) 174 are not removable from the lateral wall 104; all of these components are part of the same unitary structure (i.e., the vessel 100) as an end product ready for use. Moreover, the various components of the resistive heating element(s) 144 and 164 and the temperature-sensing element(s) 174 may all be formed on the lateral wall 104 at the same radial distance relative to the central axis 202, thus forming a single level of circuitry. That is, for instance, the resistive heating element(s) 144 and 164 do not need to be located at a different radial distance from the temperature-sensing element(s) 174. Moreover, the resistive heating element(s) 144 and 164 and the temperature-sensing element(s) 174 do not need to be sandwiched between different layers of material. The resistive heating element(s) 144 and 164 and the temperature-sensing element(s) 174 may be formed as part of the vessel 100 by any suitable technique. In some implementations, the resistive heating element(s) 144 and 164 and the temperature-sensing element(s) 174 are formed by dispensing a liquid or paste of an electrically conductive material onto the lateral wall 104 according to a desired pattern. Examples of dispensing include, but are not limited to, ink printing, pad printing, and silk screening. The compositions of the resistive heating element(s) 144 and 164 and the temperature-sensing element(s) 174 may depend on the fabrication technique utilized, but generally will be materials exhibiting an amount of electrical resistivity or conductivity suitable for transferring heat to the vessel 100 or sensing temperature. Examples of compositions of the resistive heating element(s) 144 and 164 and the temperature-sensing element(s) 174 include, but are not limited to, conductive or resistive inks, epoxies, or the like, and generally any material that may be applied to the lateral wall 104 according to a desired pattern or arrangement and yield a desired electrical conductivity or resistivity. The composition may include a metal or a conductive polymer. A specific example is a silver-containing ink such as the product designated 118.41 commercially available from Creative Materials, Tyngsboro, Mass. The lateral wall 104 may have any composition suitable for dissolution testing and compatible with the direct bonding of the resistive heating element(s) 144 and 164 and the temperature-sensing element(s) 174, examples including various glasses and polymers.

The only other material that may be desired to be added as part of the direct vessel heating area 140 is a protective layer 190, the boundaries of which are indicated by dashed lines in FIGS. 1-4. The protective layer 190 is likewise bonded directly to the components of the resistive heating element(s) 144 and 164 and the temperature-sensing element(s) 174, and to the regions of the outer surface of the lateral wall 104 between these components. The protective layer 190 may cover all or a portion of the direct vessel heating area 140. The protective layer 190 may be composed of any material that provides desired types of protections for these components (e.g., electrical insulation, thermal insulation, protection from oxidation, etc.). Examples of materials suitable for the protective layer 190 include, but are not limited to, clear dielectric coatings, clear PVC coatings such as may be employed as adhesives for medical devices, or the like. A specific example is the product designated 1-20323 commercially available from Dymax Corporation, Torrington, Conn.

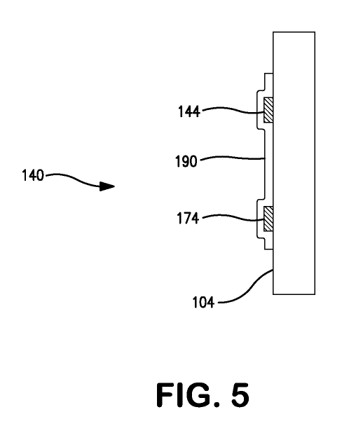

FIG. 5 is a cross-sectional elevation view of a portion of the vessel 100. Representative sections of the resistive heating element 144 (or 164) and the temperature-sensing element 174 are bonded directly to the lateral wall 104 of the vessel 100, at the same radial distance from the lateral wall 104. A representative section of the protective layer 190 is bonded directly to the resistive heating element 144, the temperature-sensing element 174 and the lateral wall 104. Accordingly, the direct vessel heating area 140 is a single-layer device that forms an integral part of the vessel 100, with the protective layer 190 optionally added.

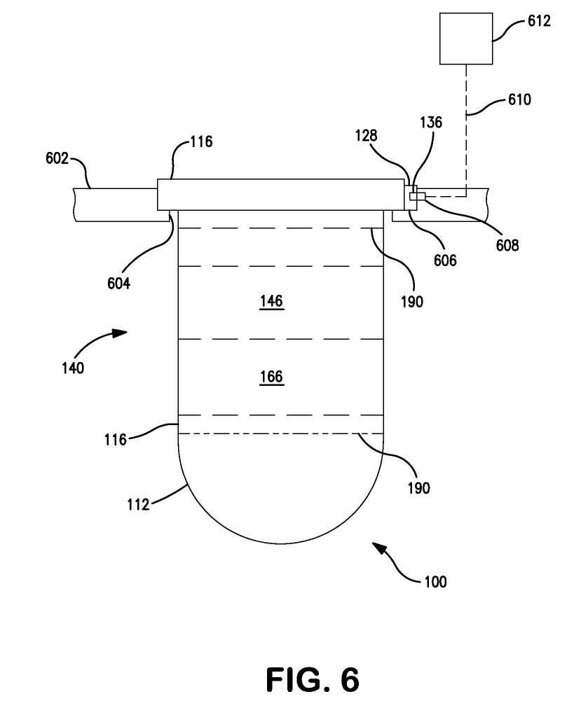

FIG. 6 is an elevation view of the vessel 100 mounted in the aperture of a vessel support member 602 that is typically provided as part of a dissolution test apparatus. The vessel support member 602 typically includes a plurality of apertures 604 so that a like number of vessels 100 may be mounted and operated during a given dissolution test. The illustrated vessel support member 602 includes a recess 606 or like feature that receives the contact block 128 that extends from the flanged section 116 of the vessel 100. The vessel support member 602 may include a set of contacts 608, such as for example pins, which are configured for connection to the second set of contacts 136 of the contact block 128 during installation of the vessel 100. By way of this interconnection and a wired or wireless communication link 610, the electrical components of the vessel 100 may communicate with a vessel heating control system 612 that may be provided with the dissolution test apparatus. The use of the contact block 128 and corresponding features of the vessel support member 602 also ensure that the vessel 100 is precisely installed on the vessel support member 602 in the same location from one dissolution test to another, thereby ensuring consistency and validation of data acquisition.

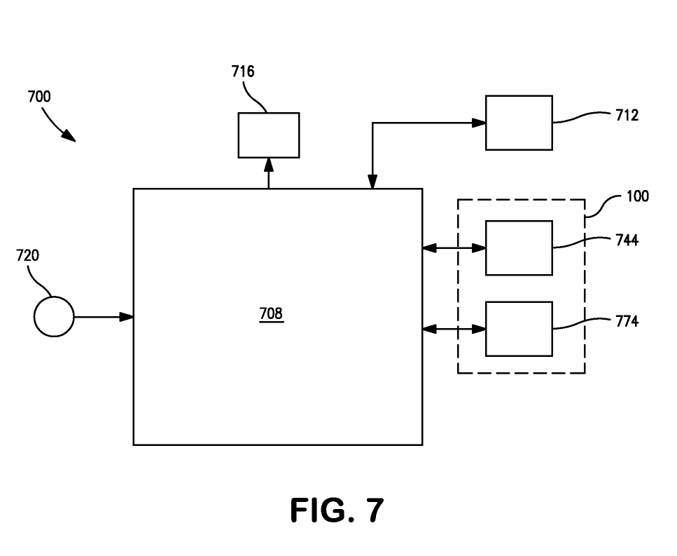

FIG. 7 is a general schematic diagram of an example of vessel heating control system 700 that may be provided with a dissolution test apparatus such as described above to interface with one or more vessels 100 with integral direct vessel heating capability as described above, and optionally also with temperature probes 704 insertable into the vessels 100. The vessel heating control system 700 generally includes an electronic controller 708 that communicates with various other components via suitable electrical lines or other types of communication links. That is, in the present schematic context, the illustrated communication lines represent wires or other physical types of electrical conduits or, alternatively, wireless transmissions of electromagnetic signals. Each vessel 100 includes one or more resistive heating element(s) 744 and temperature-sensing element(s) 774 as described above. The vessel heating control system 700 may include circuitry for presenting readouts of media temperature values based on measurement signals received from the temperature-sensing elements 774 of each vessel 100 and/or temperature probes 704 inserted in respective vessels 100 if temperature probes 704 are also provided. The vessel heating control system 700 may also include vessel heating control circuitry that communicates with or is part of the electronic controller 708. As appreciated by persons skilled in the art, the electronic controller 708 may be processor-based and include analog and/or digital attributes as well as hardware, firmware and/or software attributes. The vessel heating control system 700 may also communicate with main control circuitry 712 of the dissolution testing apparatus over a dedicated communication link and hence can be housed within a suitable control unit of the dissolution testing apparatus such a head assembly.

The electronic controller 708 communicates the resistive heating elements 744 of the respective vessels 100 to heat the media contained in the vessels 100 by controlling the power supplied thereto. The electronic controller 708 is thus able to independently control the heating of each vessel 100. The electronic controller 708 also communicates with each temperature-sensing element 774, and each temperature probe 704 if provided, associated with each vessel 100, and thus is able to monitor the temperatures of the respective volumes of media contained in each vessel 100 at any given instance of time based on measurement signals received from the temperature-sensing elements 774 and/or temperature probes 704. The electronic controller 708 may be configured to continuously monitor media temperatures in real time, thus providing temperature readouts and heater control on a real-time basis or any other temporal or event-driven basis desired by the user. The temperature probe 704 may be utilized to provide feedback of temperature data for purposes complementary to the temperature-sensing elements 774. As an example, the temperature probe 704 may be utilized to monitor start-up conditions. Once the set-point temperature in the vessel 100 has been reached and the system is stabilized, the temperature probe 704 may be removed from the vessel 100 and all further temperature monitoring handled by the temperature-sensing element 774 of the vessel 100. The temperature probe 704 may also be utilized on an as-needed basis to verify that the temperature-sensing element(s) 774 and/or resistive heating element(s) 744 of a given vessel 100 are operating properly. Each temperature probe 704 may be inserted into and subsequently removed from the respective vessel 100 manually or by automated means provided by the dissolution test apparatus. In other implementations, the temperature-sensing elements 774 of the vessels 100 provide all temperature-monitoring tasks and separate temperature probes 704 are not utilized.

In the illustrated example, the electronic controller 708 also communicates with a peripheral readout or display device 716 such as an LCD screen or the like that is configured to display temperature readings taken from the vessels 100, and may also display other information pertinent to the vessel heating process. The electronic controller 708 may also communicate with a peripheral input device 720 such as a keypad for enabling user input of vessel media set-point temperature, a variable or incremental temperature curve, and other appropriate system parameters for each vessel 100.

In operation during a dissolution test, the user may operate the peripheral input device 720 to enter a set point temperature value, or a programmed temperature profile, according to which the media temperature in the vessels 100 installed at the dissolution test apparatus is to be maintained. The user has the additional option of setting different operating temperatures for each vessel 100 or each defined group of vessels 100. The electronic controller 708 controls the operation of the heating elements 744 to ensure that an appropriate amount of power is being provided to maintain media temperature at the predetermined value. The temperature-sensing elements 774 measure and monitor media temperature in the vessels 100 by generating measurement signals periodically, continuously, or according to some other user-defined temporal or event-driven basis as described above, and transmit the measurement signals to the electronic controller 708. In this manner, the electronic controller 708 is able to monitor the rise in media temperature in each vessel 100, determine whether the media temperature in a given vessel 100 has stabilized at the previously inputted set point, and determine whether the media temperature has deviated from the set point or predetermined varying profile by greater than some predetermined error tolerance (e.g., ±0.05° C.) over some predetermined period of time (e.g., 10 seconds). When vessel media temperature needs to be adjusted to correct for a deviation, or needs to vary according to a predetermined profile, the electronic controller 708 transmits appropriate control signals to the heating elements 744 so that an appropriate amount of heat energy is transferred to the media. The electronic controller 708 may also utilize the measurement signals received from the temperature-sensing elements 774 and/or temperature probes 704 to determine whether a heating element 744 has malfunctioned, such as by failing to heat the vessel 100 or heating the vessel 100 in an excessive or uncontrolled manner. If such alert conditions are detected, the electronic controller 708 may operated to shut the heating system 700 down.

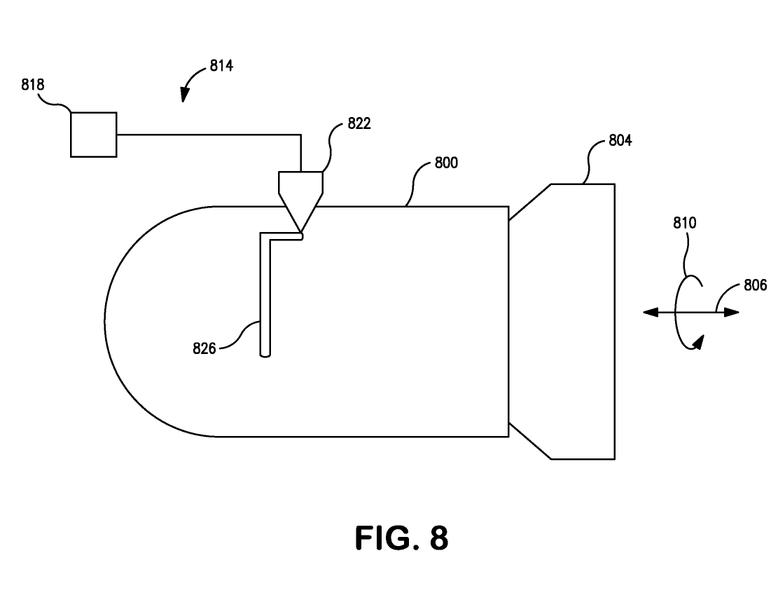

FIG. 8 illustrates an example of a method for fabricating a vessel 800 with direct vessel heating capability according to one implementation of the present disclosure. The vessel 800 is mounted to a lathe 804 capable of moving the vessel 800 in two or more directions. For example, the lathe 804 may translate the vessel 800 linearly in a direction 806 along the axis of the vessel 800 and rotate the vessel 800 in a direction 810 about the axis. A printing or drawing system 814 is utilized in this example. The printing system 814 may include a supply and transport device 818 (e.g., pump, reservoir, etc.) that fluidly communicates with a dispensing device 822 (e.g., a pen, hollow stylus, nozzle, etc.) to supply a flowable medium (electrical conductive ink or paste, etc.) to the hollow tip of the dispensing device 822. The vessel 800 is positioned such that the tip of the dispensing device 822 is proximate to the outer surface of the vessel 800. Flow of the flowable medium is established and the lathe 804 is operated to move the vessel 800 along two or more directions. Movement of the lathe 804 is programmed such that the dispensing device 822 prints a resistive heating element or temperature-sensing element 826 onto the vessel 800 in a desired pattern. In alternative implementation, the dispensing device 822 is also movable in two or more dimensions, or the dispensing device 822 is movable while the lathe 804 or other means for mounting the vessel 800 remains stationary during the printing process.

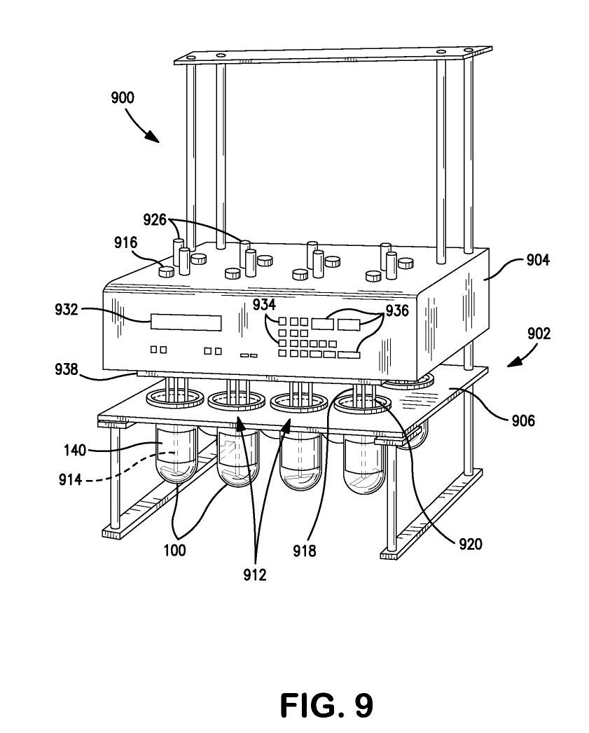

FIG. 9 is a perspective view of an example of a dissolution test apparatus 900 according to an implementation of the present disclosure. The dissolution test apparatus 900 may include a frame assembly 902 supporting various components such as a main housing, control unit or head assembly 904, and a vessel support member (e.g., a plate, rack, etc.) 906 below the head assembly 904. The vessel support member 906 supports a plurality of vessels 100 arranged in a desired array at a plurality of vessel mounting sites 912. Each vessel 100 includes a direct vessel heating area 140 that forms an integral part of the vessel 100 and is configured as described above. FIG. 1 illustrates eight vessels 100 by example, but it will be understood that more or less vessels 100 may be provided. The vessels 100 may be locked and centered in place on the vessel support member 906 by means such as ring lock devices or clamps (not shown). Alternatively, the vessels 100 themselves may be configured to have centering capability as noted above. Vessel covers (not shown) may be provided to prevent loss of media from the vessels 100 due to evaporation, volatility, etc.

The head assembly 904 may include mechanisms for operating or controlling various components that operate in the vessels 100 (in situ operative components). For example, the head assembly 904 typically supports stirring elements 914 that include respective motor-driven spindles and paddles operating in each vessel 100. Individual clutches 916 may be provided to alternately engage and disengage power to each stirring element 914 by manual, programmed or automated means. The head assembly 904 also includes mechanisms for driving the rotation of the stirring elements 914. The head assembly 904 may also include various other in situ operative components, two such operative components 918 and 920 being illustrated by example, and mechanisms for operating or controlling these operative components 918 and 920. As examples, the operative components 918 and 920 may include, for any given vessel 100, an optional temperature probe as described above, a fiber-optic probe for measuring analyte concentration in the media, media transport cannulas for dispensing and/or aspirating media to and from the vessel 100, a pH detector, a dosage form holder (e.g., USP-type apparatus such as a basket, net, cylinder, disk, etc.), a video camera, etc. A dosage delivery module 926 may be utilized to preload and drop dosage units (e.g., tablets, capsules, or the like) into selected vessels 100 at prescribed times and media temperatures. Additional examples of mechanisms for operating or controlling various in situ operative components are disclosed for example in above-referenced U.S. Pat. No. 6,962,674, assigned to the assignee of the present disclosure.

The head assembly 904 may include a programmable systems control module for controlling the operations of various components of the dissolution test apparatus 900 such as those described above. As also noted above in conjunction with FIG. 7, the head assembly 904 may also include a vessel heating control system (module, circuitry, etc.) that interfaces with the components of the direct vessel heating area 140 of each vessel 100 as well as with a temperature probe if provided. Peripheral elements may be located on the head assembly 904 such as an LCD display 932 for providing menus, status and other information; a keypad 934 for providing user-inputted operation and control of spindle speed, temperature, test start time, test duration and the like; and readouts 936 for displaying information such as RPM, temperature, elapsed run time, vessel weight and/or volume, or the like.

The dissolution test apparatus 900 may further include one or more movable components for lowering operative components 914, 918, 920 into the vessels 100 and raising operative components 914, 918, 920 out from the vessels 100. The head assembly 904 may itself serve as this movable component. That is, the entire head assembly 904 may be actuated into vertical movement toward and away from the vessel support member 906 by manual, automated or semi-automated means. Alternatively or additionally, other movable components 938 such as a driven platform may be provided to support one or more of the operative components 914, 918, 920 and lower and raise the components 914, 918, 920 relative to the vessels 100 at desired times.

In a typical operation, each vessel 100 is filled with a predetermined volume of dissolution media by pumping media to the media dispensing cannulas from a suitable media reservoir or other source (not shown). One of the vessels 100 may be utilized as a blank vessel and another as a standard vessel in accordance with known dissolution testing procedures. Dosage units are dropped either manually or automatically into one or more selected media-containing vessels 100, and each stirring element 914 (or other agitation or USP-type device) is rotated within its vessel 100 at a predetermined rate and duration within the test solution as the dosage units dissolve. In other types of tests, a cylindrical basket or cylinder (not shown) loaded with a dosage unit is substituted for each stirring element 914 and rotates or reciprocates within the test solution. For any given vessel 100, the temperature of the media may be maintained at a prescribed temperature (e.g., approximately 37±0.5° C.) if certain USP dissolution methods are being conducted or according to a predetermined temperature profile as described above. Media temperature is maintained by operating the components of the direct vessel heating area 140 of each vessel 100 as described above. The various operative components 914, 918, 920 provided may operate continuously in the vessels 100 during test runs. Alternatively, the operative components 914, 918, 920 may be lowered manually or by an automated assembly 904 or 938 into the corresponding vessels 100, left to remain in the vessels 100 only while sample measurements are being taken at allotted times, and at all other times kept outside of the media contained in the vessels 100. During a dissolution test, sample aliquots of media may be pumped from the vessels 100 via the media aspiration cannulas and conducted to an analyzing device (not shown) such as, for example, a spectrophotometer to measure analyte concentration from which dissolution rate data may be generated. In some procedures, the samples taken from the vessels 100 are then returned to the vessels 100 via the media dispensing cannulas (if provided) or separate media return conduits (if provided). Alternatively, sample concentration may be measured directly in the vessels 100 by providing fiber-optic probes as appreciated by persons skilled in the art. After a dissolution test is completed, the media contained in the vessels 100 may be removed via the media aspiration cannulas or separate media removal conduits.

In general, terms such as “communicate” and “in . . . communication with” (for example, a first component “communicates with” or “is in communication with” a second component) are used herein to indicate a structural, functional, mechanical, electrical, signal, optical, magnetic, electromagnetic, ionic or fluidic relationship between two or more components or elements. As such, the fact that one component is said to communicate with a second component is not intended to exclude the possibility that additional components may be present between, and/or operatively associated or engaged with, the first and second components.

It will be further understood that various aspects or details of the invention may be changed without departing from the scope of the invention. Furthermore, the foregoing description is for the purpose of illustration only, and not for the purpose of limitation—the invention being defined by the claims.

What is claimed is:

1. A dissolution test vessel configured for direct vessel heating, comprising:
a lateral wall disposed about a longitudinal axis of the vessel and comprising an upper end, a lower end axially spaced from the upper end, and an outside surface extending from the upper end to the lower end;
a resistive heating element bonded directly to the outside surface wherein the resistive heating element is integral with the lateral wall and non-removable therefrom, the resistive heating element comprising a first heating element end, a second heating element end, and a heating element section contiguously running from the first heating element end, over a heating zone of the lateral wall and to the second heating element end, the heating element section running along at least two different directions; and
a temperature-sensing element bonded directly to the outside surface wherein the temperature-sensing element is integral with the lateral wall and non-removable therefrom, the temperature-sensing element comprising a first sensing element end, a second sensing element end, and a sensing element section contiguously running from the first sensing element end, over a temperature sensing zone of the lateral wall and to the second sensing element end, the sensing element section running along at least two different directions.

2. The dissolution test vessel of claim 1, further comprising a clear film bonded directly to the outside surface and covering at least a portion of the resistive heating element and the temperature-sensing element

3. The dissolution test vessel of claim 1, further comprising a plurality of bond pads electrically connected to the respective first heating element end, the second heating element end, the first sensing element end, and the second sensing element end.

4. The dissolution test vessel of claim 1, further comprising an electrical contact element disposed at the upper end and comprising a first set of electrical contacts and a second set of electrical contacts, the first set of electrical contacts communicating with the respective first heating element end, the second heating element end, the first sensing element end, and the second sensing element end, and the second set of electrical contacts communicating with the first set of electrical contacts and configured for connection to a heater control circuit external to the dissolution test vessel.

5. The dissolution test vessel of claim 1, further comprising a flanged section disposed about the longitudinal axis and circumscribing the upper end, the flanged section comprising an electrical contact element, the electrical contact element comprising a first set of electrical contacts and a second set of electrical contacts, the first set of electrical contacts communicating with the respective first heating element end, the second heating element end, the first sensing element end, and the second sensing element end, and the second set of electrical contacts communicating with the first set of electrical contacts and configured for connection to a heater control circuit external to the dissolution test vessel.

6. The dissolution test vessel of claim 5, wherein the electrical contact element is removably attached to the flanged section.

7. The dissolution test vessel of claim 5, wherein the electrical contact element extends radially outward from an outermost diameter of the flanged section relative to the longitudinal axis.

8. The dissolution test vessel of claim 1, wherein the resistive heating element is a first resistive heating element, the heating element section is a first heating element section, and the heating zone is a first heating zone, and further comprising a second resistive heating element bonded directly to the outside surface and comprising a third heating element end, a fourth element end, and an elongated second heating element section contiguously running from the third heating element end, over a second heating zone of the lateral wall and to the fourth heating element end, the second heating element section running along at least two different directions.

9. The dissolution test vessel of claim 8, wherein the first heating zone is disposed axially above the second heating zone, and the temperature sensing zone is disposed at least partially within the second heating zone.

10. A dissolution test apparatus configured for direct vessel heating, comprising:
a vessel support member having an aperture;
a heater control system; and
a vessel mounted at the vessel support member, the vessel comprising:
a lateral wall disposed about a longitudinal axis of the vessel and comprising an upper end, a lower end axially spaced from the upper end, and an outside surface extending from the upper end to the lower end;
a resistive heating element bonded directly to the outside surface wherein the resistive heating element is integral with the lateral wall and non-removable therefrom, the resistive heating element comprising a first heating element end in signal communication with the heater control system, a second heating element end in signal communication with the heater control system, and an elongated heating element section contiguously running from the first heating element end, over a heating zone of the lateral wall and to the second heating element end, the heating element section running along at least two different directions; and
a temperature-sensing element bonded directly to the outside surface wherein the temperature-sensing element is integral with the lateral wall and non-removable therefrom, the temperature-sensing element comprising a first sensing element end in signal communication with the heater control system, a second sensing element end in signal communication with the heater control system, and an elongated sensing element section contiguously running from the first sensing element end, over a temperature sensing zone of the lateral wall and to the second sensing element end, the sensing element section running along at least two different directions.

11. The dissolution test apparatus of claim 10, further comprising a clear film bonded directly to the outside surface and covering at least a portion of the resistive heating element and the temperature-sensing element.

12. The dissolution test apparatus of claim 10, wherein the vessel further comprises an electrical contact element disposed at the upper end and comprising a first set of electrical contacts and a second set of electrical contacts, the first set of electrical contacts communicating with the respective first heating element end, the second heating element end, the first sensing element end, and the second sensing element end, and the second set of electrical contacts communicating with the first set of electrical contacts and with the heater control system.

13. The dissolution test apparatus of claim 10, wherein the vessel further comprises a flanged section disposed on the vessel support member and circumscribing the upper end, the vessel alignment ring comprising an electrical contact element, the electrical contact element comprising a first set of electrical contacts and a second set of electrical contacts, the first set of electrical contacts communicating with the respective first heating element end, the second heating element end, the first sensing element end, and the second sensing element end, and the second set of electrical contacts communicating with the first set of electrical contacts and with the heater control system.

14. The dissolution test apparatus of claim 13, wherein the vessel support member comprises a set of vessel support member electrical contacts in signal communication with the heater control system, and the second set of electrical contacts of the electrical contact element are removably connected to the respective vessel support member electrical contacts.

15. The dissolution test apparatus of claim 10, wherein the electrical contact element extends radially outward from an outermost diameter of the flanged section relative to the longitudinal axis and into a recess of the vessel support member.

16. The dissolution test apparatus of claim 10, wherein the vessel support member includes a plurality of apertures, the vessel is one of a plurality of vessels mounted at the respective apertures, each vessel includes a respective resistive heating element and a temperature-sensing element, and each resistive heating element and temperature-sensing element is in signal communication with the heater control system.

17. A method for fabricating a dissolution test vessel, the method comprising:
depositing a first flowable material directly on an outside surface of a lateral wall of a vessel to form a resistive heating element integral with and non-removable from the lateral wall, the resistive heating element comprising a first heating element end, a second heating element end, and an elongated heating element section contiguously running from the first heating element end, over a heating zone of the lateral wall and to the second heating element end, the heating element section running along at least two different directions;
depositing a second flowable material directly on the outside surface to form a temperature-sensing element integral with and non-removable from the lateral wall, the temperature-sensing element comprising a first sensing element end, a second sensing element end, and an elongated sensing element section contiguously running from the first sensing element end, over a temperature sensing zone of the lateral wall and to the second sensing element end, the sensing element section running along at least two different directions; and
attaching a contact block to an upper end of the vessel and placing the contact block in electrical communication with the resistive heating element and the temperature-sensing element.

18. The method of claim 17, further comprising applying a clear film directly to the outside surface wherein the film covers at least a portion of the resistive heating element and the temperature-sensing element.

19. The method of claim 17, wherein the first flowable material and the second flowable material are selected from the group consisting of conductive inks, resistive inks, conductive epoxies, and resistive epoxies.

20. The method of claim 17, further comprising attaching a flanged section to the upper end, wherein the contact block is attached to the flanged section.
